(19) United States
(12) Patent Application Publication
(10) Pub. No.: US 2010/0149071 A1
(43) Pub. Date: Jun. 17, 2010

(54) Convenient Configurations for Secondary Mini Monitors

(76) Inventor: Edward Mun-Song Son, (US)

Correspondence Address: EDWARD M SON, 2124 WIMBLETON CT, PEARLAND, TX, 77581, US

(21) Appl. No.: 12/498,388

(22) Filed: Jul. 7, 2009

Related U.S. Application Data
(60) Provisional application No. 61/122,398, filed on Dec. 14, 2008.

(51) Int. Cl. G09G 5/00

(52) U.S. Cl. 345/1.1

(57) ABSTRACT

Three configurations for attaching a secondary mini monitor to a main monitor are described. One configuration allows for a totally separate portable unit which attaches to the main monitor by an attachment unit. It is powered and driven off of a USB port from the computer. Another configuration is actually built into the side of the main monitor and shares the same power source and data connectors with the main monitor. A third configuration allows for a detachable mini monitor which can be plugged into the side of the main monitor which exposes data and power connectors in the form of USB or PCMCIA ports.

### CROSS-REFERENCE TO RELATED APPLICATIONS

This application claims the benefit of U.S. Provisional Application No. 61/122,398, filed Dec. 14, 2008.

### FIELD OF THE INVENTION

The present invention relates to three configurations for attaching a mini monitor to a main monitor as a secondary monitor.

### BACKGROUND OF THE INVENTION

A previous U.S. Pat. No. 7,034,777 describes a method for attaching a secondary monitor to a computer via its USB data port. The secondary monitor is both powered and driven off of the USB port.

However, this invention does not address the issue of providing this secondary mini monitor as a “convenient” accessory to the main monitor, either as a portable or structurally integrated part of the main monitor.

### BRIEF DESCRIPTION OF THE INVENTION

The current invention proposes configurations for the secondary monitor to a specific purpose, namely to provide “convenient” methods of presenting a secondary monitor to the main monitor. Although the following description primarily focuses on the monitors of a laptop, it can be adapted to any type of monitors for desktops as well, both flat-screen and CRT.

One configuration allows for the secondary mini monitor to be attached to the main monitor via an attachment unit. This configuration allows for the mini monitor to be driven and powered off a USB connection from the main computer.

A secondary configuration allows for the mini monitor to be built into the main monitor. It is pulled out for use, which acts as a switch to activate it. Since it is built into the main monitor, it can be configured to share its data cable as well as power supply.

As such this secondary configuration avoids some of the pitfalls of a USB connection, allowing for faster video refresh, greater resolution, and a more reliable power supply. However, since it is attached to the main monitor, it fails to be a detachable and therefore a portable solution for other laptop units.

A third approach is to expose data and power ports from the main monitor either as a USB or a PCMCIA port. Other types of data ports are possible, such as a modified video port supplying both video signal and power. To this port an external mini monitor can be attached to receive both data and power. This external mini monitor can also be easily detached for storage and transport.

The main purpose of this mini monitor would be to allow for a secondary viewing port from the working area of the main monitor, such as for viewing a video, a secondary document, or stock ticker, etc.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

“Mini monitor” henceforth shall refer to a secondary mini-sized monitor which is attached to the main monitor and serves as a secondary viewing port.

“Attachment unit” henceforth shall refer to a mechanism used to fasten the secondary mini monitor to the main monitor.

“Embedded mini monitor” henceforth shall refer to a secondary mini-sized monitor which is structurally integrated into the main monitor and serves as a secondary viewing port when pulled out.

“Embedded mini monitor bay”, or simply “mini monitor bay”, henceforth shall refer to the rectangular compartment within the main monitor into which the embedded mini monitor is inserted for storage.

“Embedded mini monitor casing”, or simply “mini monitor casing”, henceforth shall refer an external housing for the embedded mini monitor bay which is inserted into the mini monitor bay inside the main monitor and fastened thereof, and from which the embedded mini monitor is actually withdrawn for use and reinserted for storage.

“Embedded mini monitor unit”, or simply “mini monitor unit”, henceforth shall refer to the combination of the “embedded mini monitor casing” and the “embedded mini monitor” itself.

“Peripheral mini monitor” henceforth shall refer to a detachable mini monitor which can be inserted into an USB or PCMCIA or specially adapted data port on the side of the main monitor.

In the drawings:

FIG. 1 shows a mini monitor which is attached to the main monitor of a laptop. It is fed from a USB connector which connects to the laptop, to deliver both its video signal and power supply.

FIG. 2 shows the attachment unit.

FIG. 3 shows a secondary configuration whereby the mini monitor is structurally integrated into the main monitor.

FIG. 4 shows the top cross-sectional view of this secondary configuration.

FIG. 5 shows an enlarged cross-sectional top view of the embedded mini monitor.

FIG. 6 shows a configuration of a peripheral mini monitor which can be attached via a data port exposed on the main monitor.

FIG. 7 shows an extended view of a mini monitor and its multiple rotational joints allowing for rotation on either the horizontal or vertical axes.

FIG. 8 is included as “one” example of the various alternative configurations that is possible under this invention's paradigm.

### DETAILED DESCRIPTION

Embodiments of the present invention are described herein in the context of designs, methods, and apparatuses for “convenient” configurations of a secondary mini monitor used as secondary viewing port to the main monitor. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the engineer's specific goals, such as compliance with design-related constraints, and that these specific goals will vary from one implementation to another and from one designer and engineer to another. Moreover, it will be appreciated that such an engineering effort might be complex and time-consuming, but would nevertheless be a routine undertaking of engineering for those of ordinary skill in the art having the benefit of this disclosure.

In accordance with the present invention, the components and/or design elements may be implemented using various types of materials and deviations from the presented design. However, those of ordinary skill in the art will recognize that such deviations may be used without departing from the scope and spirit of the inventive concepts disclosed herein.

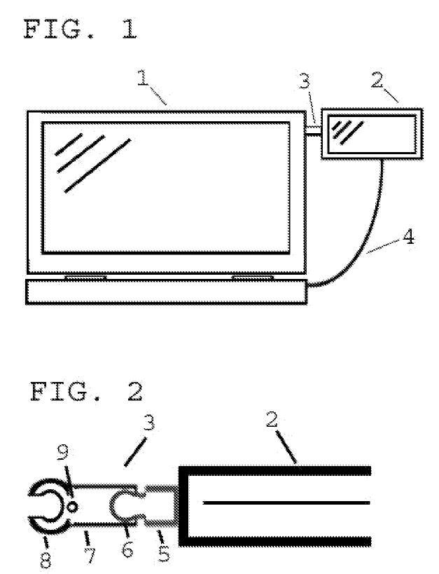

FIG. 1 shows a laptop with its main monitor 1. A secondary mini monitor 2 is attached via an attachment unit 3 to the main monitor 1. This secondary monitor 2 is fed in via a USB data connector 4 for both its video and power. This USB data cable 4 can be retractable into the body of the mini monitor 1 for storage when not in use.

The video for this secondary monitor would be driven by any standard video driver capable of supporting two or more simultaneous displays.

FIG. 2 shows an enlarged view of the attachment unit 3. The mini monitor 2 in this configuration comes with an attachment unit 3 already attached to its side.

The attachment unit 3 is composed of a base block 5 attached to the mini monitor 2. The base block 5 is formed into a rounded ball 6 on its other end. There is a cylindrical block 7 which has a corresponding hollow cavity fitted over the rounded ball 6. This configuration allows the mini monitor 2 to be rotated freely about (in 3-dimensions) allowing for better viewing positions. The cylindrical block 7 is also composed of a clasp 8 rotating about an axis 9. This clasp 8 is used to attach the attachment unit 3 to a main monitor (not shown here).

This is just one of the possible configurations for an attachment unit. Many possible configurations are readily available which allows 1) for the mini monitor to be easily affixed to the main monitor at any of its free sides, either one of its horizontal sides or the top side, and 2) for the mini monitor to be easily moved about (in 3-dimensions) in its affixed position for better viewing. Any method or system that fulfills these general claims falls within the field and ken of an appropriate design for the attachment unit.

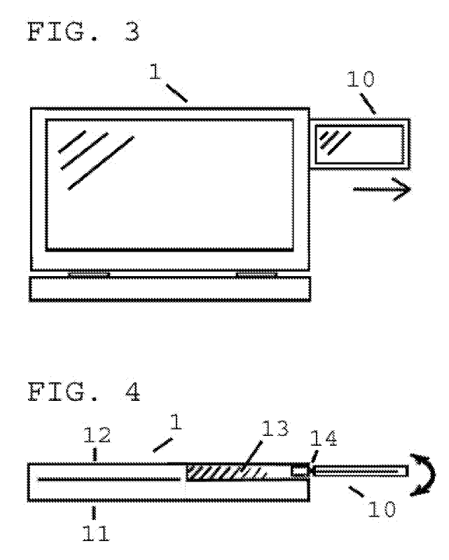

FIG. 3 shows a secondary configuration of an embedded mini monitor 10 with respect to the main monitor 1. In this scenario the mini monitor 10 is encased inside a mini monitor bay within the backside of the main monitor 1, in such as way that it can be either pushed in flush with the main monitor 1 or pulled out or pulled out of the main monitor 1. Some sort of an internal catch of course prevents the embedded mini monitor 10 from being pulled all the way out. Pulling it out activates mini monitor 10 and pushing it in deactivates it.

Because it is permanently attached to the main monitor 1, the embedded mini monitor 10 can share its data cabling as well as power supply. However, it is normally not detachable to be used with another laptop.

However it is not hard to imagine a configuration which would allow the embedded mini monitor unit to be detached from the main monitor 1 completely. Often laptops come with detachable disc reader/writers, detachable floppy drives, and detachable batteries, etc. Likewise the embedded mini monitor 10 can be configured to be released from the main monitor 1 by releasing a catch-release switch which can free the embedded mini monitor unit from its mini monitor bay. In this way the detached embedded mini monitor unit can be used with other main monitors configured to use it. The benefit of this configuration is that the embedded mini monitor unit can be switched out in the event of malfunctioning or taken out to be used with other main monitors 1 configured to use it. However it is still not a totally independent solution as the first configuration.

Moreover since this mini monitor 10 must be structurally encased within the main monitor 1 there are certain structural constraints imposed by this arrangement. Primarily the main monitor 1 must be thick enough and correspondingly the mini monitor unit must be thin enough for this arrangement to be feasible. Certain extremely thin design for flat-screen monitors may test the limits of feasibility for this arrangement. In such as case it may be necessary to allow the structural housing of the mini monitor bay to protrude slightly out from the backside of the main monitor 1.

Further there are other possible arrangements of attaching the secondary mini monitor 10 which does not imply a structural housing inside the main monitor 1. Such as one in which the mini monitor 10 is “externally” attached against the backside of the main monitor 1 along some sort of a slider mechanism. However, in this configuration the mini monitor 10 is less protected than being inserted into a mini monitor bay of some sort and is only presented as an example of many different configurations possible.

FIG. 4 shows a top cross-sectional view of this secondary configuration. The front 11 of the main monitor 1 contains its normal flat screen: there is a hollow rectangular mini monitor bay 13 on its side and toward the back 12 of the main monitor 1 and few inches down from the top of the main monitor 1. From this compartment 13, the mini monitor 10 can be pulled out to activate it. Normally it is pushed flush against the main monitor 1 into this mini monitor bay 13 for storage and deactivation. In this configuration, the mini monitor 10 is connected to a rotational axis 14 also allowing it be positioned for better viewing.

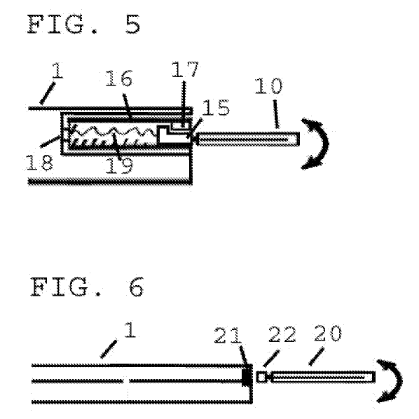

FIG. 5 shows enlarged cross sectional top view of the configuration for the embedded mini monitor 10 showing additional internal details of embedded configuration.

This serves as one possible configuration for this arrangement and in no way serves to limit the scope of the design principles covered in the suggestion for the embedded configuration, namely a bay area inside the main monitor 1 into which the mini monitor 10 can be inserted, a way for the mini monitor 10 to be inserted and withdrawn, a catch mechanism for preventing complete withdrawal of the mini monitor 10, a mechanism for activating the system by the action of pulling out the mini monitor 10, a way of connecting the mini monitor 10 to the internal data cabling and power supply of the main monitor 1, and a mechanism for the complete removal of the mini monitor unit from the main monitor 1 for the purpose of switching it out.

This particular design essentially involves a hollow cavity (mini monitor bay) in one side of the main monitor 1 into which a mini monitor casing 16 is inserted. This casing 16 serves a dual purpose of interfacing with the internal data cabling and power ports as well as an internal housing mechanism for the mini monitor 10 itself. This casing 16 also serves purpose of preventing the mini monitor 10 from being released totally during its pull-out activation because it is itself fastened inside the mini monitor bay, but can also be released from the internal bay by releasing a catch-release mechanism situated on the back of the main monitor 1 (not shown here) much in the same way a CD/DVD drive unit is released from a laptop.

This casing 16 makes contact with data and power ports 18 exposed internally within the main monitor 1. This data and power port 18 is connected via a data and power cable 19 inside the casing 16 to the base of the mini monitor 10. The mini monitor 10 itself is connected to a base section 15 at a rotational axis which allows the monitor to be positioned for better viewing. This base section 15 catches against a catch-switch mechanism 17 inside the casing 16. This catch-switch mechanism 17 serves a dual purpose of preventing the mini monitor 10 from sliding out completely during activation and also as a switch to activate the mini monitor 10 when the base unit 15 pushes against it.

FIG. 6 shows a third possibility, which is a peripheral mini monitor 20 as an external device inserted into a data port 21 on one edge of the main monitor 1 much like the way a PCMCIA or USB device is inserted into its PCMCIA slot or USB port. The data port 21 can serve as both the mini monitor's data and power source. In this configuration the peripheral mini monitor 20 is inserted via its data connectors 22 to corresponding data ports 21 on the main monitor 1 for activation and usage, and removed for storage.

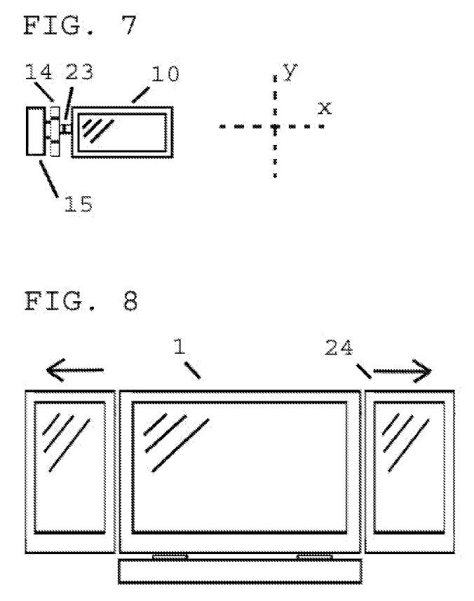

FIG. 7 shows extended view of how a mini monitor 10 can be attached via two rotational joints on both the horizontal and vertical axes allowing for 3-dimensional positioning with respect to the main monitor. Up to this point any rotational joints of the mini monitors were shown simply as a single joint. But this diagram shows that it can be composed of multiple rotational joints allowing for full range of control. This diagram exemplifies this arrangement for the “embedded mini monitor” design, but is exemplary for the “peripheral mini monitor” design as well.

Here the mini monitor 10 is attached via a rotational joint 23 which allows for rotation about the x axis. It is also joined at another rotational joint 14 to the base unit 15 which allows for rotation about the y axis. This combination of rotate-ability allows the mini monitor 10 to be rotated in 3-dimensions with respect to the main monitor and with respect to the user, for better viewing.

FIG. 8 shows that the mini monitors 24 can come in various sizes and configurations with respect to the main monitor 1 and also be configured with plurality of mini monitors with respect to the main monitor.

Moreover it is further possible that mini monitors can be mixed and matched in terms of their attachment mode with respect to the main monitor to allow for plurality of configurations. The possibilities are only limited by the number of additional video displays that the system video driver can support.

Also there is no reason why the secondary monitor in question need be a “mini-sized” monitor. It can be a secondary monitor of any size or shape as shown in this figure, such as a secondary monitor 23 of the same height as the main monitor 1. The essential point is that these secondary monitors can be “attached” to the main monitor, “easily” activated, and “easily” stored away for portability.

While various embodiments of the present invention have been described above, it should be understood that they have been presented by way of example, and not limitation. It will be apparent to persons skilled in the relevant art(s) that various changes in form and detail can be made therein without departing from the spirit and scope of the invention. Thus the present invention should not be limited by any of the above-described exemplary embodiments, but should be defined only in accordance with the specified claims and their equivalents.

The essential claim of the invention is that secondary monitors can be attached to a main monitor in any number of “convenient” configurations to allow for secondary viewing ports, at the same time allowing for ease of portability, connectivity, storage, configuration, and aesthetic appeal. Any method or system that fulfills any or all of these general claims falls within the field and ken of this present invention.

The purpose of the present invention was to demonstrate three or more possible implementations of the underlying spirit and intention of the invention. It is easy to imagine further elaboration of the present demonstration as well as a totally different method or mode of its implementation without departing from the scope and spirit of the claims of the present invention.

### REFERENCE CITED

### Patents:

U.S. Pat. No. 7,034,777 Mini monitor on shared peripheral bus

1) A way of attaching a secondary mini monitor to the main monitor by an attachment unit. The secondary mini monitor is driven off of a USB cable which connects to a USB port on the computer for both power and video signal.

2) A way of encasing a secondary mini monitor within the body of the main monitor for storage. This mini monitor can be pulled out for activation and usage. The mini monitor connects to internal data and power source as the main monitor.

3) The method for attaching a secondary monitor in claims 2 such that the mini monitor unit and its encasing can be removed from the main monitor completely for replacement or for usage with another main monitor.

4) A way of attaching a secondary mini monitor to the main monitor whereby USB or PCMCIA or other data port is exposed on one edge of the main monitor for both data and power. The mini monitor can be removed for storage and transport.

5) The methods for attaching a secondary monitor in claims 1, 2, and 3 such that the mini monitor can be rotated horizontally (as well as vertically) for better viewing.

6) The methods for attaching a secondary monitor in claims 1, 2, and 3 such that one or more secondary monitors of various size and shape can be attached to the main monitor in convenient ways for both storage and portability.
